(19) United States
(12) Patent Application Publication
(10) Pub. No.: US 2011/0295881 A1
(43) Pub. Date: Dec. 1, 2011

(54) MERGING COMPUTER PRODUCT, METHOD, AND APPARATUS

(75) Inventors: Aya YAMAGUCHI, Kawasaki (JP); Yoshimi Toyoshima, Kawasaki (JP)

(73) Assignee: FUJITSU LIMITED, Kawasaki (JP)

(21) Appl. No.: 13/074,548

(22) Filed: Mar. 29, 2011

(30) Foreign Application Priority Data
May 31, 2010 (JP) 2010-124867

(51) Int. Cl. G06F 17/30

(52) U.S. Cl. 707/769; 707/E17.014

(57) ABSTRACT

A computer-readable, non-transitory medium that stores therein a merging program that causes a computer capable of accessing a database that stores therein a data group, to execute a process that includes specifying, from the data group, first data and second data that are mergeable; identifying, from the data group, third data that are mergeable with the first data specified at the specifying; determining the second data specified at the specifying and the third data identified at the identifying as mergeable data; and outputting a determination result obtained at the determining.

### CROSS REFERENCE TO RELATED APPLICATIONS

This application is based upon and claims the benefit of priority of the prior Japanese Patent Application No. 2010-124867, filed on May 31, 2010, the entire contents of which are incorporated herein by reference.

### FIELD

The embodiments discussed herein are related to merge processing.

### BACKGROUND

Merging/purging for confirming the identity of depositor who has multiple accounts in a financial institution is conventionally known. In a broad interpretation, merging/purging includes identifying, from a data group accumulated in a database, data that can be integrated or deleted when, for example, due to corporate merger, internal corporate data are to be integrated and/or redundant customer information is to be integrated or deleted.

In conventional merging/purging, for example, data to be subject to processing are obtained from a database, and notations thereof are made uniform, variants in notation are corrected, character strings are separated and split, etc. (i.e., standardization, cleansing). For example, one-byte characters and two-byte characters, notations such as “Corp.” and “Corporation”, variant notations such as “optimization” and “optimisation” are made uniform, and “Corporation” is separated from the corporate name.

Candidate data to be merged are extracted from the uniform data based on an extraction condition set in advance. For example, data (hereinafter, “reference data”) to which data to be merged (hereinafter, “comparison data”) are compared are extracted. For example, the degree of similarity between the comparison data and the reference data is calculated to compare the comparison data and the reference data.

Based on the comparison result, it is determined whether the comparison data are mergeable with the reference data. The resulting determination is regarded as merge results and input to a commercial data integration apparatus, for example. Merging/purging based on the merge results is performed by a merge/purge program stored in a storage device of the data integration apparatus. A method of determining identity for merge/purge is disclosed in, for example, Japanese Laid-Open Patent Publication No. 2006-018340 and Japanese Patent No. 3721315.

In conventional merging/purging, however, an operator looks through the merge results generated by a computer and determines whether the comparison data and the reference data are mergeable. In reality, it is difficult for the operator to look through all comparison results since the operator has to check a vast number of data (e.g., several millions of data).

Further, an erroneous determination due to an error of the operator may result in a discrepancy in the merge result data. Thus, the number of data to be checked by the operator has to be narrowed down to a realistic number.

Furthermore, it is inevitable at present that comparison results automatically generated by a computer are used as the merge result data as they are, since the operator has to check a vast number of data. In this case, the comparison condition has to be stricter to exclude unmergeable data from being merged.

Furthermore, although conventional merging/purging can separate data into groups each of which includes mergeable data, it is difficult to determine one reference datum for multiple data.

### SUMMARY

According to an aspect of an embodiment, a computer-readable, non-transitory medium stores therein a merging program that causes a computer capable of accessing a database that stores therein a data group, to execute a process that includes specifying, from the data group, first data and second data that are mergeable; identifying, from the data group, third data that are mergeable with the first data specified at the specifying; determining the second data specified at the specifying and the third data identified at the identifying as mergeable data; and outputting a determination result obtained at the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a hardware configuration of a merging apparatus according to a first embodiment.

FIG. 2 is a diagram of exemplary dataflow according to the first embodiment.

FIG. 3 is a block diagram of a functional configuration of the merging apparatus according to the first embodiment.

FIG. 4 is a diagram of an example of a merge process according to the first embodiment.

FIG. 5 is a diagram of an example of candidate records before the merge process according to the first embodiment.

FIGS. 6 to 11 are diagrams of an example of candidate records during the merge process according to the first embodiment.

FIG. 12 is a diagram of the comparison/reference data according to the first embodiment.

FIGS. 13 to 19 are diagrams of an example of a process in which groups are integrated according to the first embodiment.

FIG. 20 is a diagram of another example of candidate records during the merge process according to the first embodiment.

FIGS. 21A and 21B are flowcharts of an exemplary procedure of the merge process according to the first embodiment.

FIGS. 22A and 22B are flowcharts of another exemplary procedure of the merge process according to the first embodiment.

FIG. 23 is a flowchart of an exemplary procedure of a group integration process according to the first embodiment.

FIG. 24 is a block diagram of a functional configuration of the merging apparatus according to a second embodiment.

FIG. 25 is a diagram of an example of the merge process according to the second embodiment.

FIG. 26 is a diagram of an example of partner records according to the second embodiment.

FIG. 27 is a diagram of an example of a determination result obtained by the merge process according to the second embodiment.

FIG. 28 is a flowchart of an exemplary procedure of the merge process according to the second embodiment.

FIG. 29 is a flowchart of an exemplary procedure of an evaluation-value calculation process according to the second embodiment.

### DESCRIPTION OF EMBODIMENTS

Preferred embodiments of the present invention will be explained with reference to the accompanying drawings.

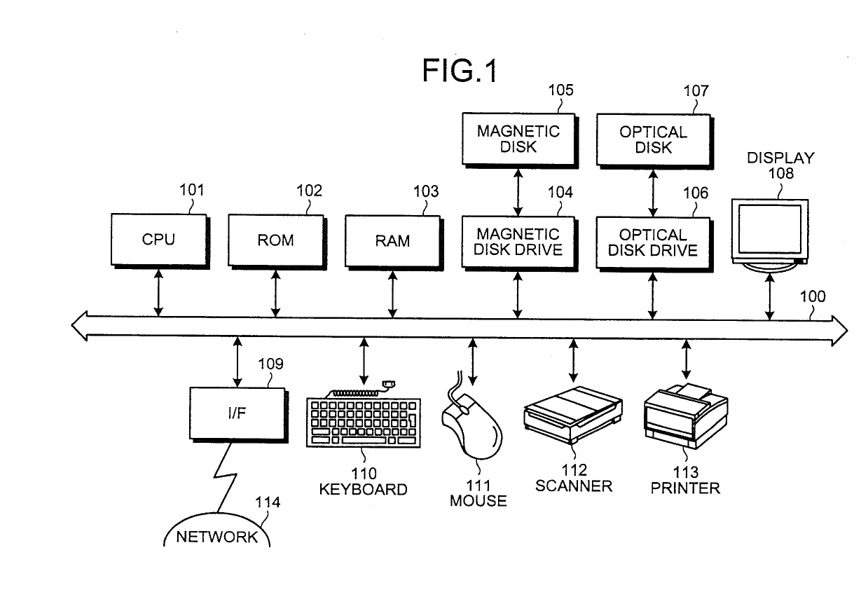

FIG. 1 is a block diagram of a hardware configuration of a merging apparatus according to a first embodiment. As depicted in FIG. 1, the merging apparatus includes a central processing unit (CPU) 101, a read-only memory (ROM) 102, a random access memory (RAM) 103, a magnetic disk drive 104, a magnetic disk 105, an optical disk drive 106, an optical disk 107, a display 108, an interface (I/F) 109, a keyboard 110, a mouse 111, a scanner 112, and a printer 113, respectively connected by a bus 100.

The CPU 101 governs overall control of the merging apparatus. The ROM 102 stores therein programs such as a boot program. The RAM 103 is used as a work area of the CPU 101. The magnetic disk drive 104, under the control of the CPU 101, controls the reading and writing of data with respect to the magnetic disk 105. The magnetic disk 105 stores therein data written under control of the magnetic disk drive 104.

The optical disk drive 106, under the control of the CPU 101, controls the reading and writing of data with respect to the optical disk 107. The optical disk 107 stores therein data written under control of the optical disk drive 106, the data being read by a computer.

The display 108 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 108.

The I/F 109 is connected to a network 114 such as the local area network (LAN), the wide area network (WAN), and the Internet via a communication line, and to other apparatuses through the network 114. The I/F 109 administers an internal interface with the network 114 and controls the input/output of data from/to external apparatuses. For example, a modem or a LAN adaptor may be employed as the I/F 109.

The keyboard 110 includes, for example, keys for inputting letters, numerals, and various instructions and performs the input of data. Alternatively, a touch-panel-type input pad or numeric keypad, etc. may be adopted. The mouse 111 is used to move the cursor, select a region, or move and change the size of windows. A track ball or a joy stick may be adopted provided each respectively has a function similar to a pointing device.

The scanner 112 optically reads an image and takes in the image data into the merging apparatus. The scanner 112 may have an optical character reader (OCR) function as well. The printer 113 prints image data and text data. The printer 113 may be, for example, a laser printer or an ink jet printer.

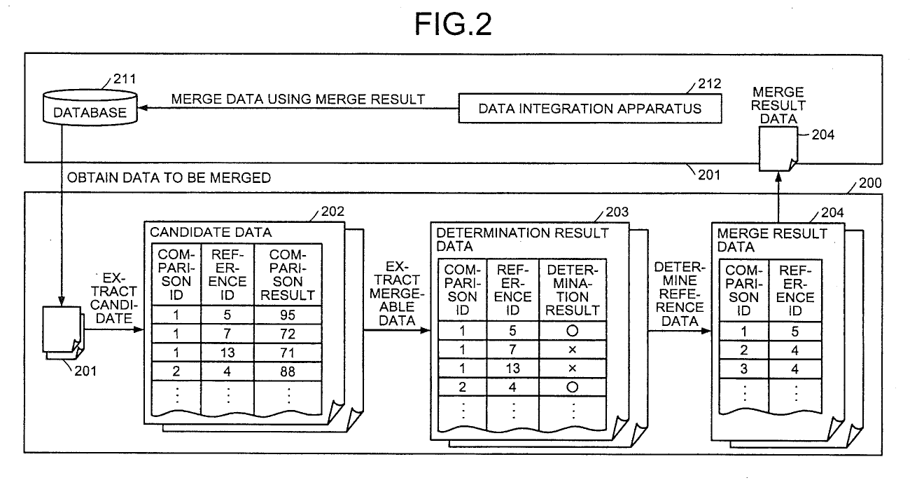

FIG. 2 is a diagram of exemplary dataflow according to the first embodiment. For example, a merging apparatus 200 accesses a database 211, obtains data from a data group to be organized (hereinafter, “target data group 201”) stored in the database 211, and extracts candidate data.

For example, the merging apparatus 200 extracts from the target data group 201, data to be merged (hereinafter, “comparison data”) and data to which the comparison data are compared (hereinafter, “reference data”). The extracted data are stored as, for example, records (hereinafter, “merge candidate record” or “candidate record”) and output in a table-format as candidate data 202.

For example, the target data group 201 may include redundant and/or similar data, or may not actually include such data but include data to be merged based on a given merge condition. Data in the target data group may have been subjected to standardization and/or cleansing.

Here, “data” mean data that can be coded in binary that can be processed by a computer, such as image data (e.g., logo mark), character-string data (e.g., word and sentence), and audio data. An example of character-string data is a corporate name, a person's name, an address, a product name, a country name, a geographical name, etc.

“Merge/purge” (hereinafter, “merge”) means associating one or more target data in the target data group with one target datum. For example, character strings “ [symbol] ”, “ [symbol] ”, “ [symbol] ”, and “ [symbol] ” that represent the same corporate name are associated with “ [symbol] ”. Character strings “ [symbol] ”, “ [symbol] ”, “ [symbol] ” (two-byte character string), “ [symbol] ” (one-byte character string), and “Tokyo” that represent the same geographical name are associated with “ [symbol] ”.

Merge may be performed by a computer, based on a similarity of character strings, for example, or may be performed based on input by an operator irrespective of whether the character strings resemble each other.

The candidate record includes, for example, an identifier of the comparison data (hereinafter, “comparison ID”) and an identifier of the reference data (hereinafter, “reference ID”). The candidate record may include a comparison result of the comparison data and the reference data. If no reference data to which the comparison data are to be compared are extracted, the generation of candidate records for the comparison data may be omitted.

The comparison result is information for comparing the comparison data and the reference data, and may be a degree of similarity (hereinafter, “similarity”) or a degree of difference (hereinafter, “dissimilarity”) between the comparison data and the reference data.

The data extracted as the comparison data from the target data group 201 may be registered in groups. For example, one comparison datum is registered in one group (hereinafter, “comparison-data group”).

By treating data as groups, it is ensured that only mergeable data are included in the same group when different groups are integrated, thereby preventing a discrepancy from occurring in the determination result.

The merging apparatus 200 determines whether the comparison data and the reference data are mergeable based on the information stored in the candidate records, details of which will be described hereinafter.

The determination result is written into determination result data 203, for example. The determination result data 203 are, for example, the candidate data 202 into which the determination result is written. The candidate data 202 and the determination result data 203 may be stored in the database 211, for example.

The comparison data may be compared to the comparison data themselves. That is, both the comparison data and the reference data may be specified from the target data group 201. Alternatively, the comparison data may be compared to master data of the target data group 201, for example. That is, the comparison data and the reference data may be specified from different data groups, respectively.

The merging apparatus 200 generates, based on the determination result data 203, merge result data 204 compatible with an input format of a typical data integration apparatus 212. For example, the merging apparatus 200 outputs, as the merge result data 204, records in which one reference datum is associated with one or more comparison data.

The merge result data 204 are input to the data integration apparatus 212 that merges data in the target data group 201, based on the merge result data 204. The target data group 201 after the merge process is stored in the database 211, for example. The merging apparatus 200 may have the function of the data integration apparatus 212.

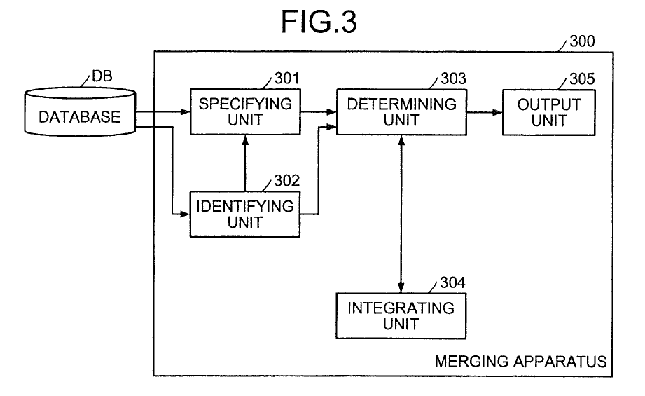

FIG. 3 is a block diagram of a functional configuration of the merging apparatus according to the first embodiment. A merging apparatus 300 includes a specifying unit 301, an identifying unit 302, a determining unit 303, an integrating unit 304, and an output unit 305. These functions (the specifying unit 301 to the output unit 305) as a controller are implemented by, for example, the I/F 109 or the CPU 101 executing a program stored in a storage device such as the ROM 102, the RAM 103, the magnetic disk 105, and the optical disk 107 depicted in FIG. 1.

The specifying unit 301 specifies from a data group, first data and second data that are mergeable. For example, the specifying unit 301 specifies data that are likely to be mergeable with the comparison data (or the reference data) from the target data group stored in the database DB.

The identifying unit 302 identifies, from the data group, third data that are mergeable with the first data specified by the specifying unit 301. The identifying unit 302 also identifies, from the data group, third data that are unmergeable with the first data specified by the specifying unit 301.

For example, the identifying unit 302 identifies whether reference data (or comparison data) in the target data group stored in the database DB are mergeable or unmergeable with the first data specified the by the specifying unit 301.

The determining unit 303 determines the second data specified by the specifying unit 301 and the third data identified by the identifying unit 302 as mergeable data. For example, the determining unit 303 determines the comparison data and the reference data as mergeable data (hereinafter, “first determination method”).

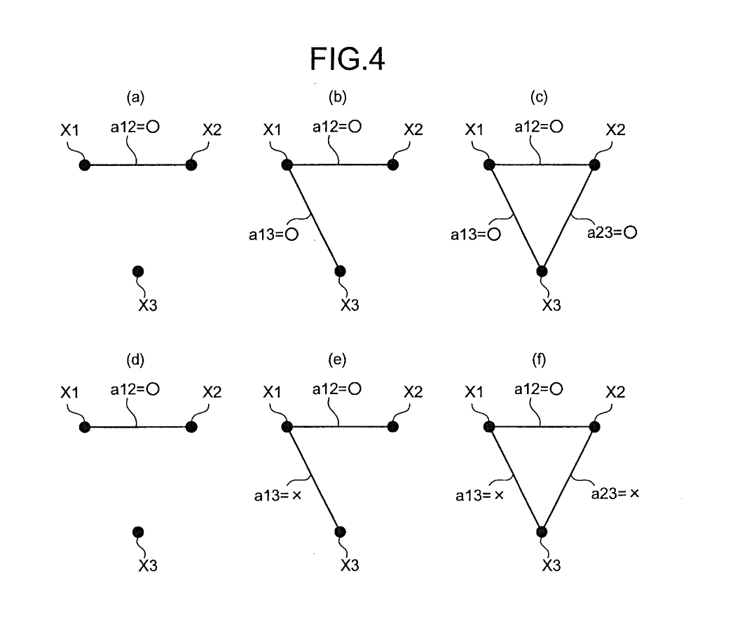

The determination result is stored in the candidate record, for example. The determined data are stored in a storage device such as the RAM 103, the magnetic disk 105, and the optical disk 107. FIG. 4 is a diagram of an example of the merge process according to the first embodiment.

Examples in which the determination result for a candidate record becomes “O” or “X” are described with reference to FIG. 4. A candidate record (2, 3) is taken as an example, where “2” is the comparison ID while “3” is the reference ID.

The determination result “O” indicates that the two data are mergeable data, while the determination result “X” indicates that the two data are unmergeable data. An example in which the determination result for the candidate record (2, 3) becomes “O” is described first.

For example, from a candidate record having comparison ID=2, the specifying unit 301 specifies first data X1 mergeable with the data of comparison ID=2. Specifically, from the candidate record (2, 1) in which the determination result is “O”, the specifying unit 301 specifies the data of reference ID=1 as the first data X1. Alternatively, the specifying unit 301 may specify the first data X1 based on the candidate record (1, 2) in which the determination result is “O”. That is, the first data X1 and the second data X2 are mergeable data, and the determination result a12 therefor is “O” (see (a) in FIG. 4).

For example, from a candidate record having a reference ID=3, the identifying unit 302 identifies the data of reference ID=3 and the first data X1 as mergeable data. Specifically, the identifying unit 302 identifies that the determination result of the candidate record (1, 3) is “O”. Alternatively, the identifying unit 302 may identify that the determination result of the candidate record (3, 1) is “O”. That is, the first data X1 and the third data X3 are mergeable data, and the determination result a13 therefor is “O” (see (b) in FIG. 4).

The determining unit 303 determines the determination result a23 for the second data X2 and the third data X3 to be “O”, based on the determination result a12=“O” and the determination result a13=“O” (see (c) in FIG. 4). Specifically, the determining unit 303 makes the determination result of the candidate record (2, 3) to be “O”. That is, the determination result a23 for the second data X2 and the third data. X3 is uniquely determined to be “O” since the determination results a12 and a13 for the first data X1 that is common to the second data and the third data are “O”.

An example in which the determination result for the candidate record (2, 3) becomes “X” is described next. For example, from a candidate record having a comparison ID=2, the specifying unit 301 specifies the first data X1 mergeable with the data of comparison ID=2. That is, the determination result a12 for the first data X1 and the second data X2 is “O” (see (d) in FIG. 4).

For example, from a candidate record having a reference ID=3, the identifying unit 302 identifies the data of reference ID=3 and the first data X1 as unmergeable data. That is, the first data X1 and the third data X3 are unmergeable data, and the determination result a13 therefor is “X” (see (e) in FIG. 4).

The determining unit 303 determines the determination result a23 for the second data X2 and the third data X3 to be “X”, based on the determination result a12=“O” and the determination result a13=“X” (see (f) in FIG. 4). That is, the determination result a23 for the second data X2 and the third data X3 is uniquely determined to be “X” since the determination result a12 or a13 is “X”.

The determination result of the candidate record (2, 3) is the same as that of the candidate record (3, 2). Thus, if the determination result is determined in the order of the candidate record (2, 3), . . . , (3, 2), for example, the determination result of the candidate record (3, 2) may be determined when that of the candidate record (2, 3) is determined, or when the candidate record (3, 2) is read after candidate records subsequent to the candidate record (2, 3) are sequentially read.

The determination result of the candidate record referred by the specifying unit 301 and the identifying unit 302 may have been determined in advance based on a given merge condition, or may be determined during the determination process by the determining unit 303.

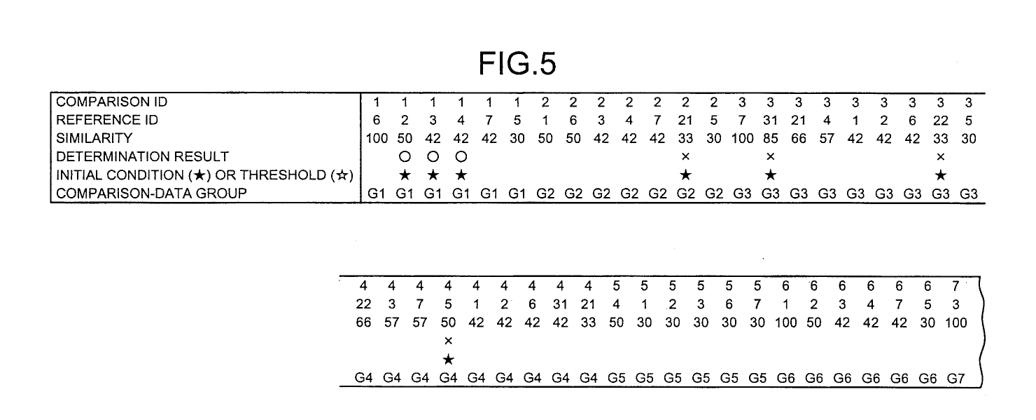

If the determination result is set in advance, an operator may check visually candidate records, for example, before the merge process and write “O” or “X” into the determination result of the candidate record. FIG. 5 is a diagram of an example of the candidate records before the merge process according to the first embodiment.

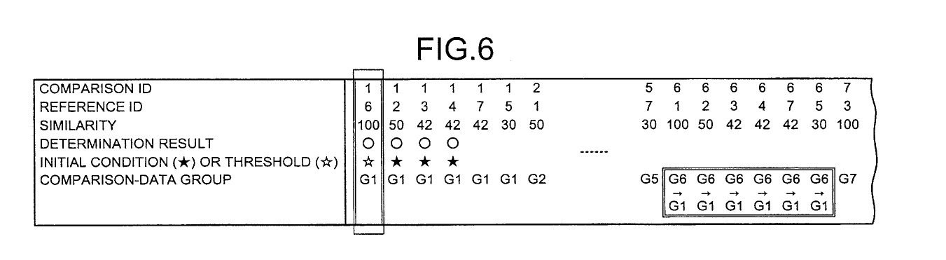

As depicted in FIG. 5, the candidate record includes the comparison ID and the reference ID. Each candidate record (comparison ID, reference ID) is written with main data to be used for the merge process such as the similarity, the determination result written by the operator (see records including a black star in the initial condition), and the comparison-data group. Only a main portion of the candidate records is depicted in FIG. 5 (the same applies to FIGS. 6 to 11 and 20 described below).

For example, the candidate record (1, 2) stores therein the following data: the comparison ID=1; the reference ID=2; and the similarity=50 obtained by comparing the data of comparison ID=1 and the data of reference ID=2. The data of comparison ID=1 and the data of reference ID=2 have been determined by the operator as mergeable data. That is, the determination result “O” is written in the candidate record (1, 2) in advance before the merge process. The data of comparison ID=1 are registered in group G1.

The initial condition or threshold of the candidate record is not a component of the candidate record, and clarifies that the determination result of the candidate record is not based on the first determination method.

That is, a black star in the initial condition or threshold indicates that the determination result has been written by the operator. A white star in the initial condition or threshold indicates that the determination result has been written based on a threshold for the comparison result. “NULL” in the initial condition or threshold indicates that the determination result of the candidate record is based on the first determination method (the same applies to FIGS. 6 to 11 and 20 described below).

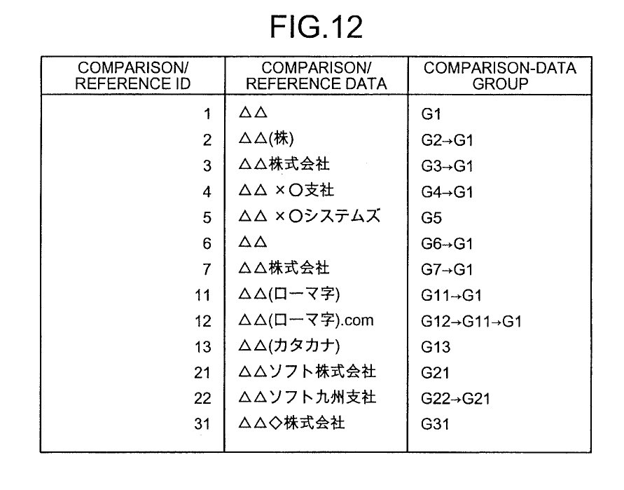

In FIG. 5, all of the main data to be used for the merge process are stored in one table. Alternatively, the data may be stored in different tables, respectively. For example, the comparison-data group may be written not in the candidate record depicted in FIG. 5, but in a different table. FIG. 12 is a diagram of the comparison/reference data according to the first embodiment.

For example, the comparison-data group may be stored for each comparison/reference ID in a table that stores the comparison/reference data for each comparison/reference ID as depicted in FIG. 12. Alternatively, only the comparison-data group may be stored for each comparison/reference ID in a table different from that of FIG. 12.

That is, the main data to be used for the merge process may be stored in one table or different tables, respectively, as long as the data can be recorded and referred to by the merging apparatus 200. Here, a table storing all of the main data is taken as an example to clarify the order in which the data are written.

Alternatively, the determining unit 303 may determine the comparison data and the reference data as mergeable data, based on the comparison result of the comparison data and the reference data (hereinafter, “second determination method”).

For example, assuming that the upper threshold of the similarity is 90, while the lower threshold is 30, the determining unit 303 determines the determination result of a candidate record to be “O”, if the similarity thereof is 90 or more. The determining unit 303 determines the determination result of a candidate record to be “X”, if the similarity thereof is 30 or less. FIGS. 6 to 11 are diagrams of an example of candidate records during the merge process according to the first embodiment.

In FIG. 6, the similarity of the candidate record (1, 6) is 100, for example. Thus, the determining unit 303 determines the determination result of the candidate record (1, 6) to be “O” (see the record including a white star).

Alternatively, the determining unit 303 may determine the comparison data and the reference data as mergeable data, if the comparison data and the reference data are included in the same group (hereinafter, “third determination method”).

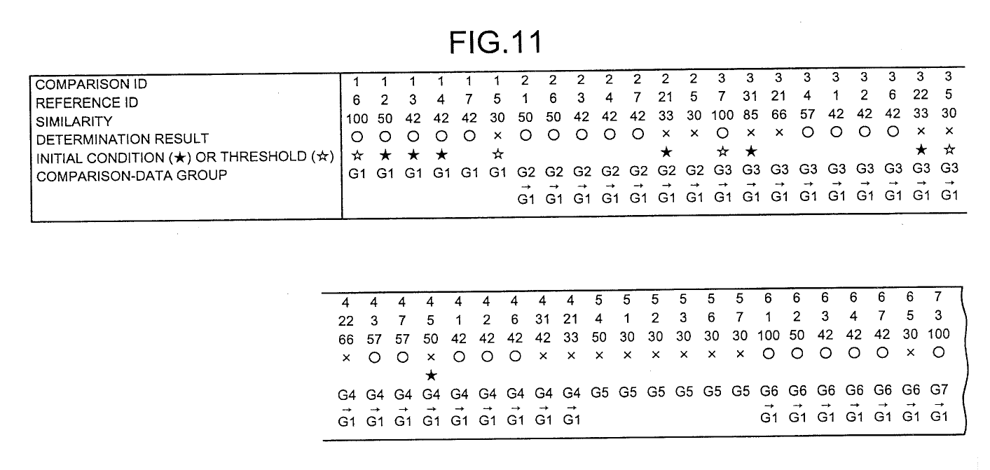

For example, the determining unit 303 determines the determination result of the candidate record (6, 1) to be “O” since the comparison-data groups of the candidate records having a comparison ID=1 or 6 are the same group G1 (see FIG. 11).

The integrating unit 304 integrates the group that includes the comparison data and the group that includes the reference data, if the determining unit 303 determines the comparison data and the reference data as being mergeable. For example, if the determination result of the candidate record (1, 6) is determined to be “O” by the determining unit 303, the integrating unit 304 changes the comparison-data groups of the candidate records having a comparison ID=6 from group G6 to group G1 as depicted in FIG. 6. The result of the integration is stored in a storage device such as the RAM 103, the magnetic disk 105, and the optical disk 107.

For example, assume that the first data X1 and the second data X2 belong to the same group in (c) of FIG. 4. In this case, if the determining unit 303 determines the second data X2 and the third data X3 as mergeable data, the integrating unit 304 integrates the group that includes the third data X3 into the group that includes the first data X1.

If the determining unit 303 further determines the first data X1 and fourth data (not depicted) as being mergeable, the integrating unit 304 further integrates the group that includes the fourth data into the group that includes the first data X1. That is, the first data to the fourth data are made to belong to the same group.

On the other hand, the determining unit 303 determines the second data X2 and the third data X3 as unmergeable data in (f) of FIG. 4. Thus, if the fourth data (not depicted) belong to the same group as the third data X3, the determining unit 303 determines the first data X1 and the fourth data as unmergeable data.

That is, if data of different groups include any combination of unmergeable data, the determining unit 303 determines the data of the different groups as unmergeable data.

An example of a process until the determination result data are generated by the determining unit 303 is described with reference to FIGS. 5 to 11. The candidate records depicted in FIG. 5 include only the determination results written by the operator before the merge process (see records including a black star). Here, it is assumed that the determining unit 303 reads the candidate records in the candidate data sequentially from the first record.

The determining unit 303 obtains the candidate record (1, 6) and determines whether the comparison-data groups of the candidate records having a comparison ID=1 or 6 are the same (the third determination method). Here, group G1 of the data of comparison ID=1 and group G6 of the data of comparison ID=6 are different, and thus the determining unit 303 tries the first determination method next.

In the first determination method, the specifying unit 301 specifies, from a candidate record having a comparison/reference ID=1, data that are mergeable (or unmergeable) with the data of comparison ID=1. Specifically, the specifying unit 301 specifies candidate records (1, 2), (1, 3), (1, 4) as the data mergeable with the data of comparison ID=1.

The identifying unit 302 identifies the data of comparison ID=6 that are mergeable (or unmergeable) with the data of comparison/reference ID=2, 3, or 4 specified by the specifying unit 301. Specifically, the identifying unit 302 identifies a candidate record including the determination result “O” from among candidate records (2, 6), (3, 6), (4, 6), (6, 2), (6, 3), (6, 4).

However, the identifying unit 302 cannot identify any data that are mergeable with the data of reference ID=6 from among the above candidate records. Thus, the determining unit 303 tries the second determination method next.

In the second determination method, the determining unit 303 merges data, based on the similarity of the candidate record (1, 6). The determining unit 303 writes “O” into the determination result of the candidate record (1, 6) since the similarity thereof exceeds the upper threshold (i.e., 90) of the similarity (see FIG. 6). In the candidate records depicted in FIGS. 6 to 11 and 20, portions that are overwritten by the merge process or the group integration process are enclosed by a double line.

While the determining unit 303 writes “O” into the determination result of the candidate record (1, 6), the integrating unit 304 changes the comparison-data groups of all candidate records into which the same group G6 as the comparison ID=6 has been written, from group G6 to group G1. The history of the change of the comparison-data group is indicated by an arrow in FIGS. 6 to 12 and 20. Specifically, “G6→G1” is depicted in the candidate record (6, 1) since group G6 is changed to group G1.

Thereafter, the determining unit 303 performs the merge process for all candidate records according to the same procedure as that for the candidate record (6, 1) described above, details of which are omitted.

The determining unit 303 skips candidate records (1, 2), (1, 3), (1, 4) in which the determination result has been already written, and performs the merge process for the candidate record (1, 7). However, the determining unit 303 cannot obtain the determination result for the candidate record (1, 7), based on the first to the third determination methods at this stage.

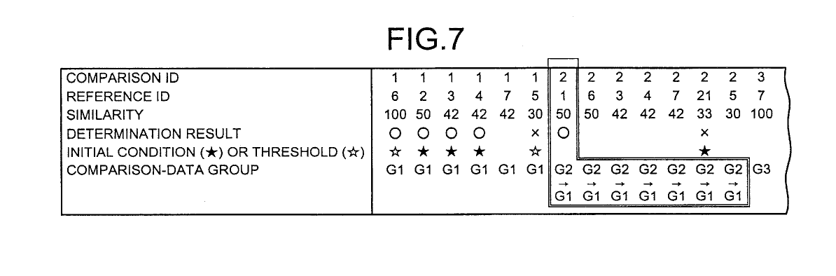

Thus, the determining unit 303 does not write anything into the determination result of the candidate record (1, 7) and performs the merge process for the next candidate record (1, 5). The determining unit 303 writes “X” into the determination result of the candidate record (1, 5), based on the second determination method (see FIG. 7). Hereinafter, description is omitted for a merge process that is not followed by the group integration process by the integrating unit 304.

The determining unit 303 writes “O” into the determination results of candidate records (2, 1), (2, 3), (2, 4), (3, 7) in this order, based on the first determination method. While “O” is written into the determination result of the candidate record (2, 1), the integrating unit 304 changes all comparison-data groups into which the same group G2 as the comparison ID=2 has been written, from group G2 to group G1 (see FIG. 7).

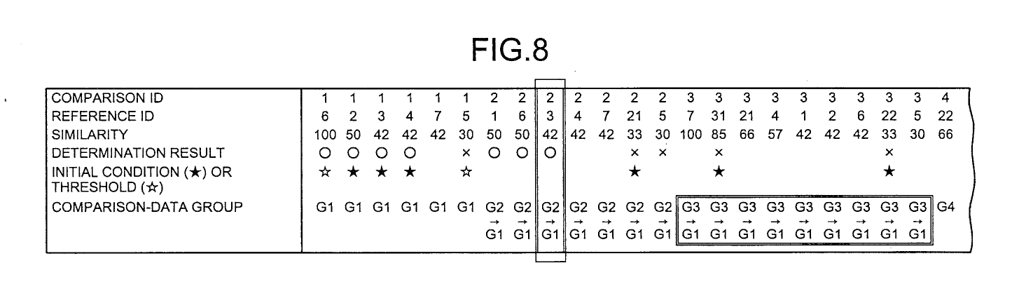

While “O” is written into the determination result of the candidate record (2, 3), the integrating unit 304 changes all comparison-data groups into which the same group G3 as the reference ID=3 has been written, from group G3 to group G1 (see FIG. 8).

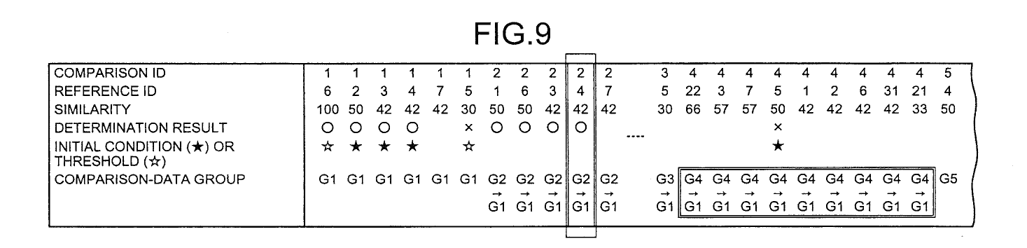

While “O” is written into the determination result of the candidate record (2, 4), the integrating unit 304 changes all comparison-data groups into which the same group G4 as the reference ID=4 has been written, from group G4 to group G1 (see FIG. 9).

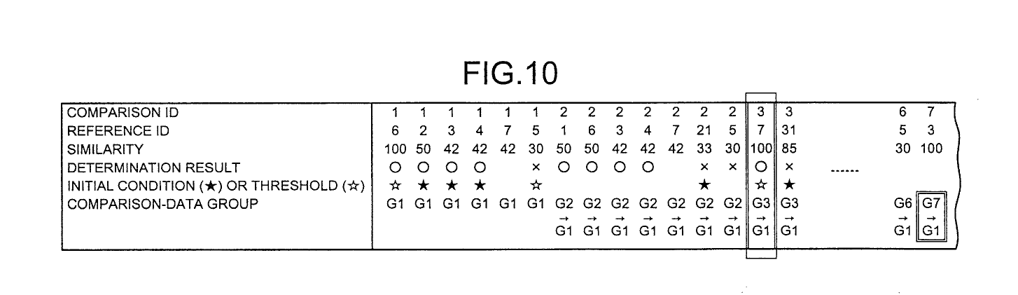

While “O” is written into the determination result of the candidate record (3, 7), the integrating unit 304 changes all comparison-data groups into which the same group G7 as the reference ID=7 has been written, from group G7 to group G1 (see FIG. 10). Thereafter, the determining unit 303 and the integrating unit 304 repeat the same process. Thus, “O” or “X” is written into the determination results of nearly all candidate records, and the determination result data are completed (see FIG. 11).

As a result, groups G2, G3, G4, G6, and G7 before the merge process are changed to group G1 as depicted in FIG. 12. That is, groups G2, G3, G4, G6, and G7 disappear due to the group integration process by the integrating unit 304 described above.

Here, the integrating unit 304 sequentially changes groups G2 to G7 to group G1. However, the order in which the comparison-data group is changed varies depending on the order in which the candidate records are read. For example, if group G7 is changed to group G3, which is then changed to group G1 and the merge process ends, group G7 before the merge process is changed to group G1 at the end of the merge process. That is, the comparison-data groups of candidate records having a comparison ID=7 are changed such as “G7→G3→G1” (not depicted).

The comparison-data groups of other candidate records (not depicted) may be overwritten manually after the entire merge process ends and the determination result data are completed. For example, the operator overwrites the comparison-data groups of the candidate records from group G11 to group G1.

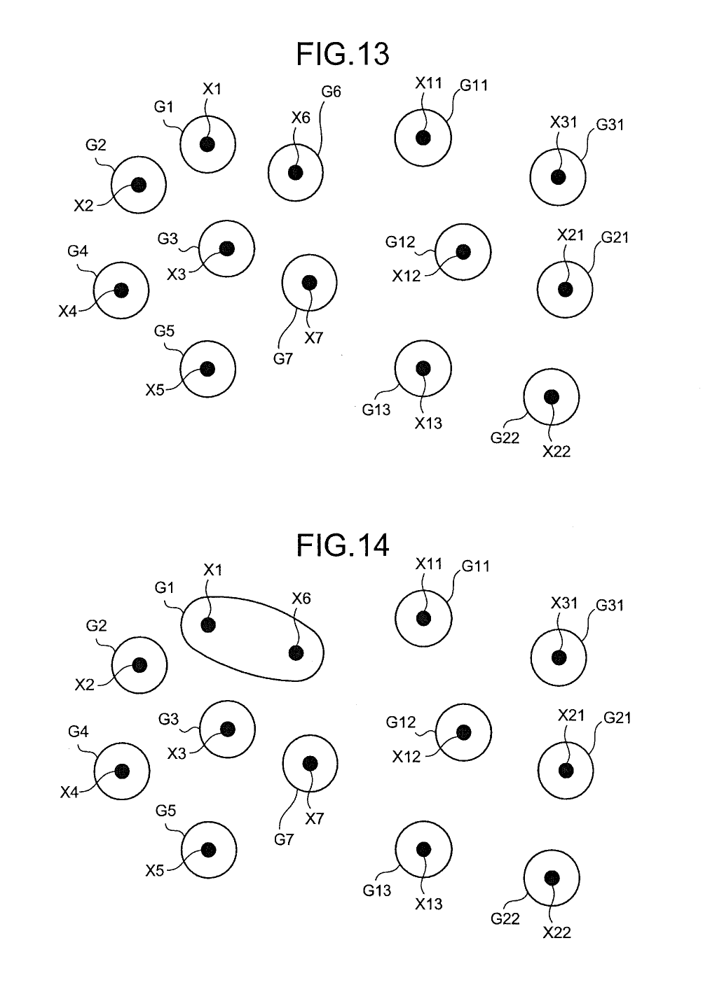

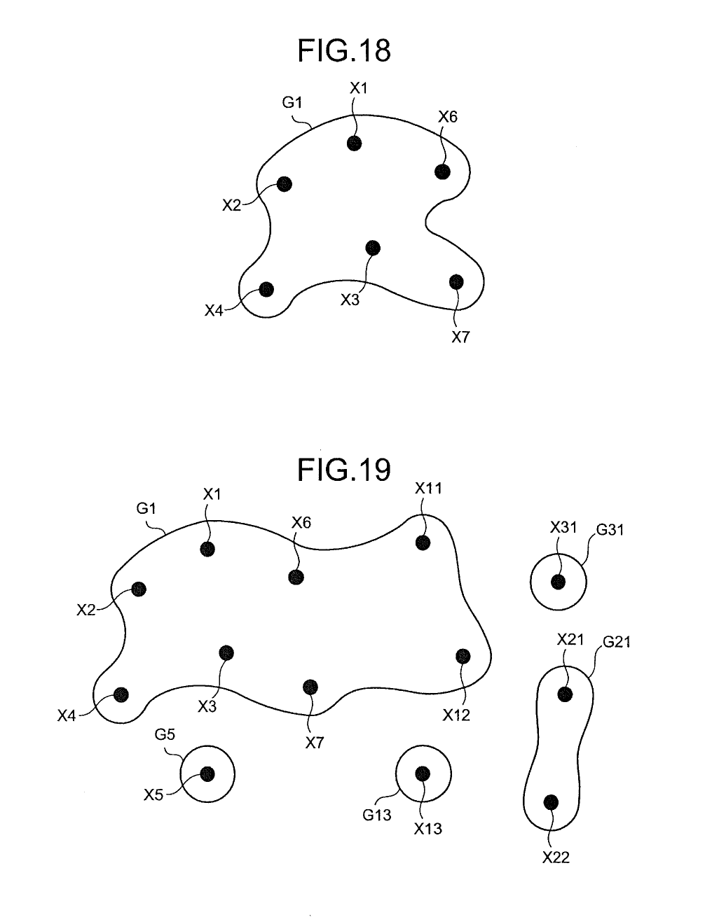

As a result, groups G11 and G12 before the merge process are changed to group G1 and disappear. That is, groups can be integrated after the merge process by the determining unit 303. FIGS. 13 to 19 are diagrams of an example of a process in which groups are integrated according to the first embodiment. States of groups integrated as depicted in FIGS. 5 to 12 are described with reference to FIGS. 13 to 19.

In FIG. 13, comparison data X1 to X31 are registered in different groups G1 to G31, respectively. FIG. 13 illustrates a state in which groups G1 to G31 are written into the comparison-data groups of candidate records (see FIG. 5). Here, the comparison data X1 to X31 are the data of comparison ID=1 to 31 depicted in FIG. 5 (the same applies to FIGS. 14 to FIG. 19 described below). The data of comparison ID=8 to 31 are omitted in FIG. 5.

In FIG. 14, group G6 is integrated into group G1 by the integrating unit 304 and disappears, as the determination result of the candidate record (1, 6) is determined to be “O” by the determining unit 303 (see FIG. 6). As a result, comparison data X6 are registered in group G1.

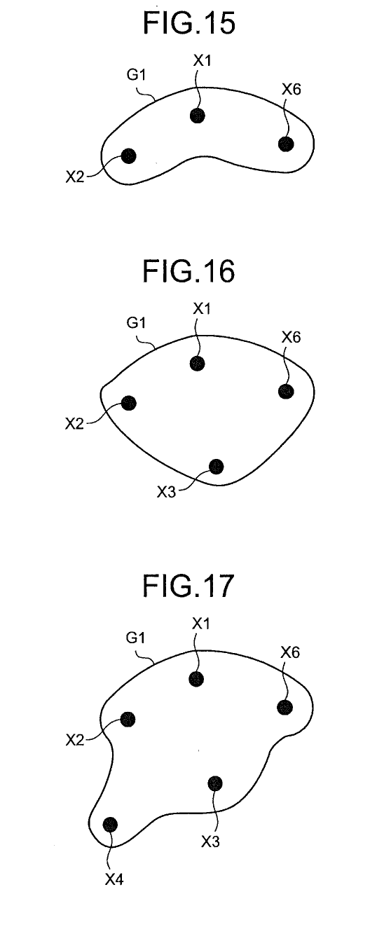

In FIGS. 15 to 18, groups G2, G3, G4, and G7 are sequentially integrated into group G1 in this order by the integrating unit 304 and disappear, as the determination results of candidate records (2, 1), (2, 3), (2, 4), (3, 7) are sequentially determined to be “O” by the determining unit 303 (see FIGS. 7 to 10). As a result, comparison data X2, X3, X4, and X7 are sequentially registered in group G1.

In FIG. 19, group G11 is integrated into group G1 and disappears, as the comparison-data group of the data of comparison ID=11 is changed from group G11 to group G1 by the operator (see FIG. 12). As a result, comparison data X11 and X12 are registered in group G1.

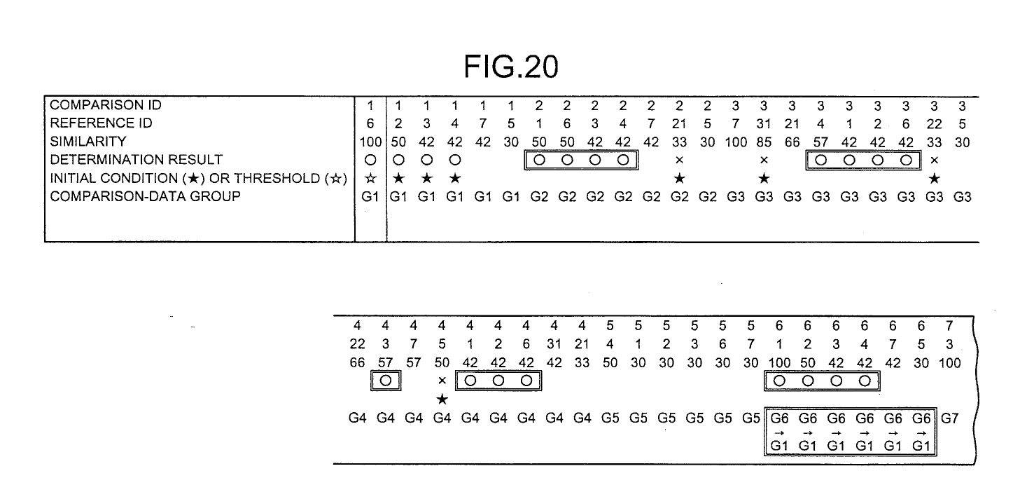

Another example of a process until the determination result data are generated is described with reference to FIG. 20. FIG. 20 is a diagram of another example of candidate records during the merge process according to the first embodiment. The determining unit 303 obtains the candidate record (1, 6) in a similar manner to the merge process depicted in FIG. 5.

In FIG. 20, the determining unit 303 determines the determination result of the candidate record (1, 6) to be “O” based on the second determination method in a similar manner to the merge process depicted in FIG. 6. The integrating unit 304 changes the comparison-data groups of all candidate records having a comparison ID=6 from group G6 to group G1 in a similar manner to the group integration process depicted in FIG. 6.

The specifying unit 301 specifies the candidate record (1, 6) of which determination result has been determined to be “O” by the determining unit 303. The identifying unit 302 identifies candidate records (1, 2), (1, 3), (1, 4) that are mergeable with the data of comparison/reference ID=1 or 6 specified by the specifying unit 301.

Thus, the determining unit 303 determines all combinations of the data of comparison/reference ID=1 or 6 specified by the specifying unit 301 and the data of comparison/reference ID=2, 3, or 4 identified by the identifying unit 302 as mergeable data.

Specifically, the determining unit 303 determines the determination results of candidate records (2, 1), (2, 3), (2, 4), (2, 6), (3, 1), (3, 2), (3, 4), (3, 6), (4, 1), (4, 2), (4, 3), (4, 6), (6, 1), (6, 2), (6, 3), (6, 4) to be “O”.

That is, the specifying unit 301 sequentially specifies combinations of mergeable data in group G1. Each time the specifying unit 301 specifies data, the identifying unit 302 identifies data mergeable with the data specified by the specifying unit 301. Thus, upon determining the determination result of the candidate record (1, 6) to be “O”, the determining unit 303 determines all combinations of data in group G1 as mergeable data.

The integrating unit 304 then performs the group integration process in which groups G2, G3, G4, and G6 are integrated into group G1 simultaneously. As described above, if the determination results of candidate records are fixed when the determination result of a given candidate record is determined, the former determination results may be determined simultaneously with the latter determination result.

The output unit 305 outputs the merge result determined by the determining unit 303. For example, the output unit 305 outputs (e.g., displays on the display 108, outputs to the printer 113, or transmits to an external apparatus by the I/F 109), based on the determination result data, the merge result data compatible with an input format of a typical data integration apparatus 212. Alternatively, the merge result data may be stored in a storage device such as the RAM 103, the magnetic disk 105, and the optical disk 107.

According to the first embodiment, the man-hour of merge operation by the operator can be reduced, thereby avoiding generation of an erroneous merge result due to operator error. Further, mergeable data and unmergeable data can be correctly identified, thereby preventing a discrepancy from occurring in the merge result.

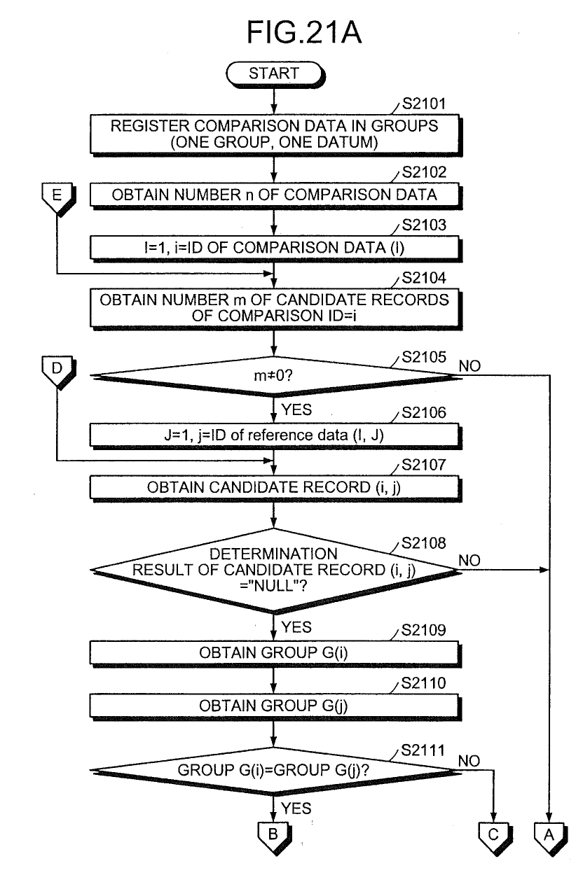

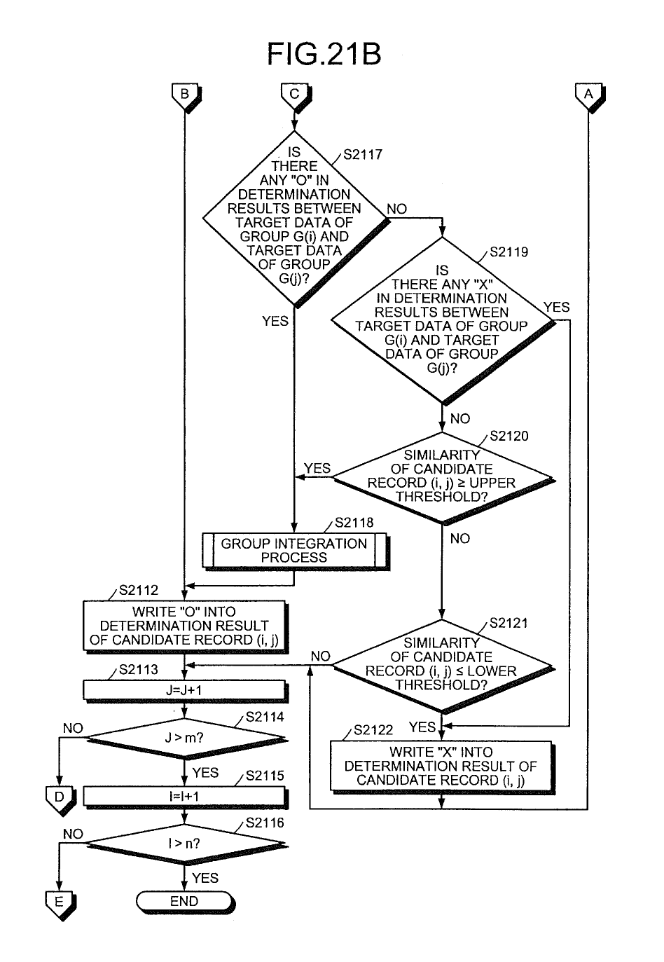

FIGS. 21A and 21B are flowcharts of an exemplary procedure of the merge process according to the first embodiment. As depicted in FIG. 21A, the merging apparatus extracts the comparison data and the reference data, and registers comparison data in groups on a one-group one-datum basis (step S2101). The determining unit 303 obtains the number (n) of comparison data (step S2102). The ID of comparison data (I) is set to a variable i, where the initial value of I is 1 (step S2103).

The determining unit 303 obtains the number (m) of candidate records having a comparison ID=i (step S2104). If there is any candidate record having a comparison ID=i (step S2105: YES), the determining unit 303 sets the ID of reference data (I, J) to a variable j, where the initial value of J is 1 (step S2106).

The determining unit 303 obtains the candidate record (i, j) (step S2107), and determines whether the determination result thereof is “NULL” (step S2108). That is, the determining unit 303 determines whether the determination result of the candidate record (i, j) has been already determined.

If the determination result of the candidate record (i, j) is “NULL” (step S2108: YES), the determining unit 303 obtains group G(i) in which the comparison data of ID=i are registered (step S2109). That is, a group in which the comparison data (I) are registered is obtained. The determining unit 303 also obtains group G(j) in which the comparison data of ID=j are registered (step S2110). That is, a group in which comparison data of the same ID as the reference data (I, J) are registered is obtained.

If group G(i) and group G(j) are identical (step S2111: YES), the determining unit 303 writes “O” into the determination result of the candidate record (i, j) (step S2112). J is incremented (step S2113) and if J does not exceed m (step S2114: NO), the process transitions to step S2107 and the determining unit 303 obtains the candidate record (i, j).

On the other hand, if group G(i) and group G(j) are not identical (step S2111: NO), the specifying unit 301 and the identifying unit 302 determine whether the determination result of a candidate record that includes the target data of group G(i) and the target data of group G(j) as the comparison/reference data has been once determined to be “O” (step S2117).

That is, at step S2117, the specifying unit 301 and the identifying unit 302 determine whether there is at least one candidate record including the determination result “O” among candidate records that include the ID of the target data of group G(i) and the ID of the target data of group G(j) as the comparison/reference ID.

If there is a candidate record including the determination result “O” (step S2117: YES), the integrating unit 304 performs the group integration process (step S2118), and the determining unit 303 writes “O” into the determination result of the candidate record (i, j) (step S2112).

On the other hand, if there is no candidate record including the determination result “O” (step S2117: NO), the specifying unit 301 and the identifying unit 302 determine whether the determination result of a candidate record that includes the target data of group G(i) and the target data of group G(j) as the comparison/reference data has been once determined to be “X” (step S2119).

That is, at step S2119, the specifying unit 301 and the identifying unit 302 determine whether there is at least one candidate record including the determination result “X” among candidate records that include the ID of the target data of group G(i) and the ID of the target data of group G(j) as the comparison/reference ID.

If there is no candidate record including the determination result “X” (step S2119: NO), the determining unit 303 determines whether the similarity of the candidate record (i, j) is equal to or greater than the upper threshold (step S2120).

On the other hand, if there is any candidate record including the determination result “X” (step S2119: YES), the determining unit 303 writes “X” into the determination result of the candidate record (i, j) (step S2122).

If the similarity of the candidate record (i, j) is equal to or greater than the upper threshold (step S2120: YES), the integrating unit 304 performs the group integration process (step S2118), and the determining unit 303 writes “O” into the determination result of the candidate record (i, j) (step S2112).

On the other hand, if the similarity of the candidate record (i, j) is below the upper threshold (step S2120: NO), the determining unit 303 determines whether the similarity of the candidate record (i, j) is equal to or less than the lower threshold (step S2121).

If the similarity of the candidate record (i, j) is equal to or less than the lower threshold (step S2121: YES), the determining unit 303 writes “X” into the determination result of the candidate record (i, j) (step S2122).

On the other hand, if the similarity of the candidate record (i, j) is above the lower threshold (step S2121: NO), J is incremented (step S2113) and if J does not exceed m (step S2114: NO), the process transitions to step S2107 and the determining unit 303 obtains the candidate record (i, j).

If the determination result of the candidate record (i, j) is not “NULL” (step S2108: NO), the process transitions to step S2113 without executing steps S2109 to S2122.

Similarly, if there is no candidate record having a comparison ID=i (step S2105: NO), the process transitions to step S2113.

If J exceeds m (step S2114: YES), I is incremented (step S2115) and if I does not exceed n (step S2116: NO), the process transitions to step S2104 and the determining unit 303 obtains the number (m) of candidate records having a comparison ID=i.

On the other hand, if I exceeds n (step S2116: YES), the merging apparatus ends the sequence of processes.

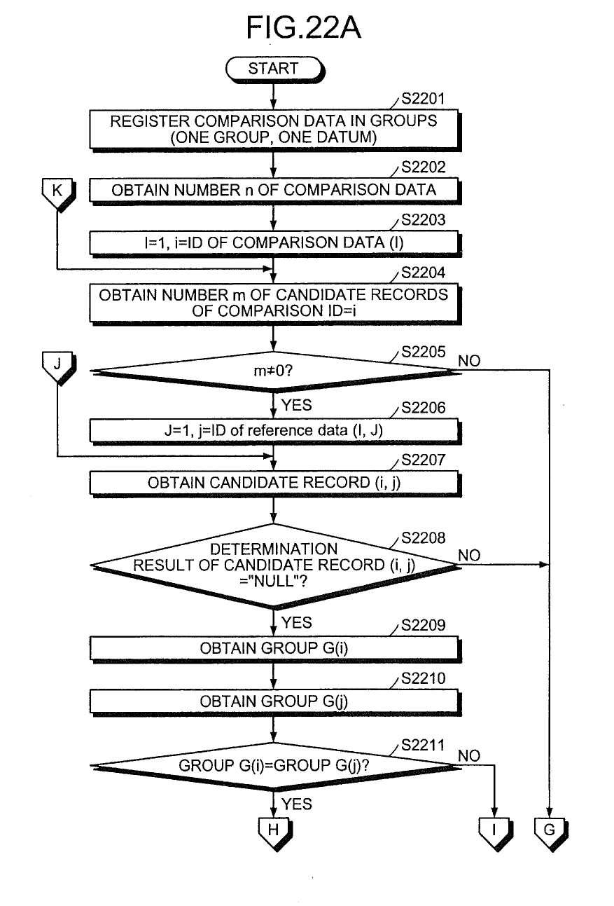

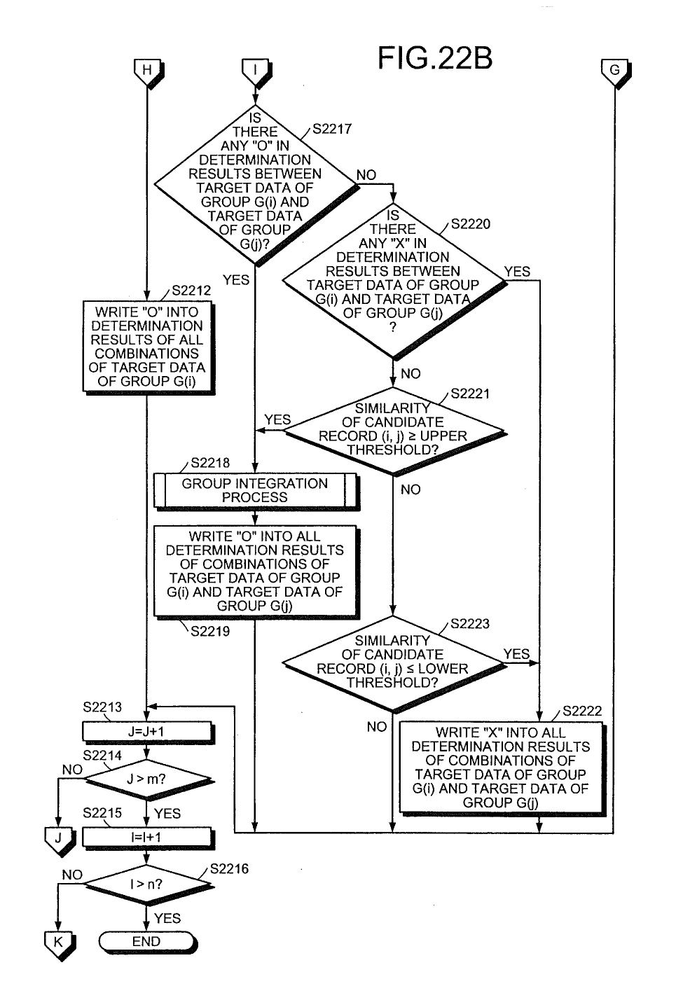

FIGS. 22A and 22B are flowcharts of another exemplary procedure of the merge process according to the first embodiment. As depicted in FIG. 22A, the merging apparatus registers comparison data in groups on a one-group one-datum basis (step S2201). The number (n) of comparison data is obtained (step S2202). The ID of comparison data (I) is set to a variable i, where the initial value of I is 1 (step S2203).

The determining unit 303 obtains the number (m) of candidate records having a comparison ID=i (step S2204). If there is any candidate record having a comparison ID=i (step S2205: YES), the determining unit 303 sets the ID of reference data (I, J) to a variable j, where the initial value of J is 1 (step S2206).

The determining unit 303 obtains the candidate record (i, j) (step S2207), and determines whether the determination result thereof is “NULL” (step S2208). That is, the determining unit 303 determines whether the determination result of the candidate record (i, j) has been already determined.

If the determination result of the candidate record (i, j) is “NULL” (step S2208: YES), the determining unit 303 obtains group G(i) in which the comparison data of ID=i are registered (step S2209). That is, a group in which the comparison data (I) are registered is obtained. The determining unit 303 also obtains group G(j) in which the comparison data of ID=j are registered (step S2210). That is, a group in which comparison data of the same ID as the reference data (I, J) are registered is obtained.

If group G(i) and group G(j) are identical (step S2211: YES), the determining unit 303 writes “O” into the determination results of all candidate records that include the target data of group G(i) as the comparison/reference data (step S2212). That is, the determining unit 303 determines all combinations of the target data of group G(i) as mergeable data.

J is incremented (step S2213) and if J does not exceed m (step S2214: NO), the process transitions to step S2207 and the determining unit 303 obtains the candidate record (i, j).

On the other hand, if group G(i) and group G(j) are not identical (step S2211: NO), the specifying unit 301 and the identifying unit 302 determine whether the determination result of a candidate record that includes the target data of group G(i) and the target data of group G(j) as one pair of the comparison/reference data has been once determined to be “O” (step S2217).

If there is any candidate record including the determination result “O” (step S2217: YES), the integrating unit 304 performs the group integration process (step S2218), and the determining unit 303 writes “O” into the determination results of all candidate records that include the target data of group G(i) and the target data of group G(j) as one pair of the comparison/reference data (step S2219). That is, at step S2219, the determination results of all candidate records that include the ID of the target data of group G(i) and the ID of the target data of group G(j) as the comparison/reference ID become “O”.

On the other hand, if there is no candidate record including the determination result “O” (step S2217: NO), the specifying unit 301 and the identifying unit 302 determine whether the determination result of a candidate record that includes the target data of group G(i) and the target data of group G(j) as one pair of the comparison/reference data has been once determined to be “X” (step S2220).

If there is no candidate record including the determination result “X” (step S2220: NO), the determining unit 303 determines whether the similarity of the candidate record (i, j) is at least equal to the upper threshold (step S2221).

On the other hand, if there is any candidate record including the determination result “X” (step S2220: YES), the determining unit 303 writes “X” into the determination results of all candidate records that include the target data of group G(i) and the target data of group G(j) as one pair of the comparison/reference data (step S2222). That is, the determination results of all candidate records that include the ID of the target data of group G(i) and the ID of the target data of group G(j) as the comparison/reference ID become “X”.

If the similarity of the candidate record (i, j) is equal to or greater than the upper threshold (step S2221: YES), the integrating unit 304 performs the group integration process (step S2218), and the determining unit 303 writes “O” into the determination result of all candidate records that include the target data of group G(i) and the target data of group G(j) as one pair of the comparison/reference data (step S2219).

On the other hand, if the similarity of the candidate record (i, j) is below the upper threshold (step S2221: NO), the determining unit 303 determines whether the similarity of the candidate record (i, j) is equal to or less than the lower threshold (step S2223).

If the similarity of the candidate record (i, j) is equal to or less than the lower threshold (step S2223: YES), the determining unit 303 writes “X” into the determination results of all candidate records that include the target data of group G(i) and the target data of group G(j) as one pair of the comparison/reference data (step S2222).

On the other hand, if the similarity of the candidate record (i, j) is above the lower threshold (step S2223: NO), J is incremented (step S2213) and if J does not exceed m (step S2214: NO), the process transitions to step S2207 and the determining unit 303 obtains the candidate record (i, j).

If the determination result of the candidate record (i, j) is not “NULL” (step S2208: NO), the process transitions to step S2213 without executing steps S2209 to S2223.

Similarly, if there is no candidate record having a comparison ID=i (step S2205: NO), the process transitions to step S2213.

If J exceeds m (step S2214: YES), I is incremented (step S2215) and if I does not exceed n (step S2216: NO), the process transitions to step S2204 and the determining unit 303 obtains the number (m) of candidate records having a comparison ID=i.

On the other hand, if I exceeds n (step S2216: YES), the merging apparatus ends the sequence of processes.

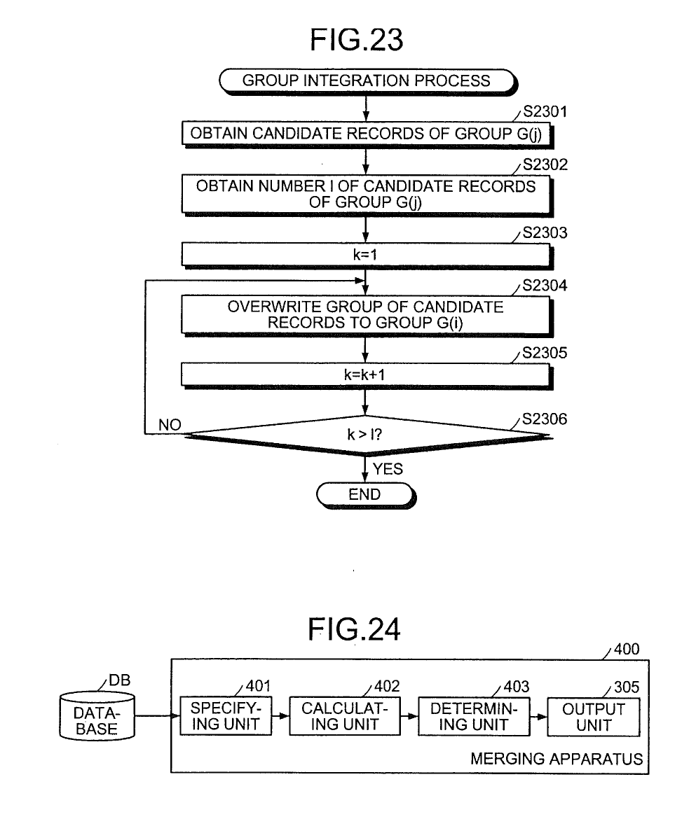

FIG. 23 is a flowchart of an exemplary procedure of the group integration process according to the first embodiment. As depicted in FIG. 23, the integrating unit 304 obtains candidate records of group G(j) (step S2301).

The integrating unit 304 obtains the number (l) of the candidate records of group G(j), and sets k to the initial value 1 (k=1) (steps S2302 and S2303). The integrating unit 304 overwrites the group of the candidate records of group G(j) to group G(i) (step S2304).

k is incremented (step S2305) and if k does not exceed 1 (k>1) (step S2306: NO), the process transitions to step S2304. If k exceeds 1 (step S2306: YES), the integrating unit 304 ends the sequence of processes.

FIG. 24 is a block diagram of a functional configuration of the merging apparatus according to a second embodiment. A merging apparatus 400 includes a specifying unit 401, a calculating unit 402, a determining unit 403, and the output unit 305. The hardware configuration of the merging apparatus 400 is the same as that of the first embodiment.

The merging apparatus 400 accesses a database DB and extracts the comparison data and the reference data that have been determined as being mergeable therewith from the target data group 201. The extracted data are stored as records (hereinafter, “merge partner record” or “partner record”), for example.

The merging apparatus 400 may generate the partner records, based on an extraction condition set in advance, for example, or based on the merge result output by the merge process according to the first embodiment. The partner record includes an identifier of the comparison data (“comparison ID”) and an identifier of the reference data (“reference ID”).

The comparison data are registered in groups based on a relevance among comparison data, for example. Specifically, multiple comparison data are registered in one group. Here, the relevance is a score that indicates how closely the target data resemble each other, such as the similarity and the dissimilarity.

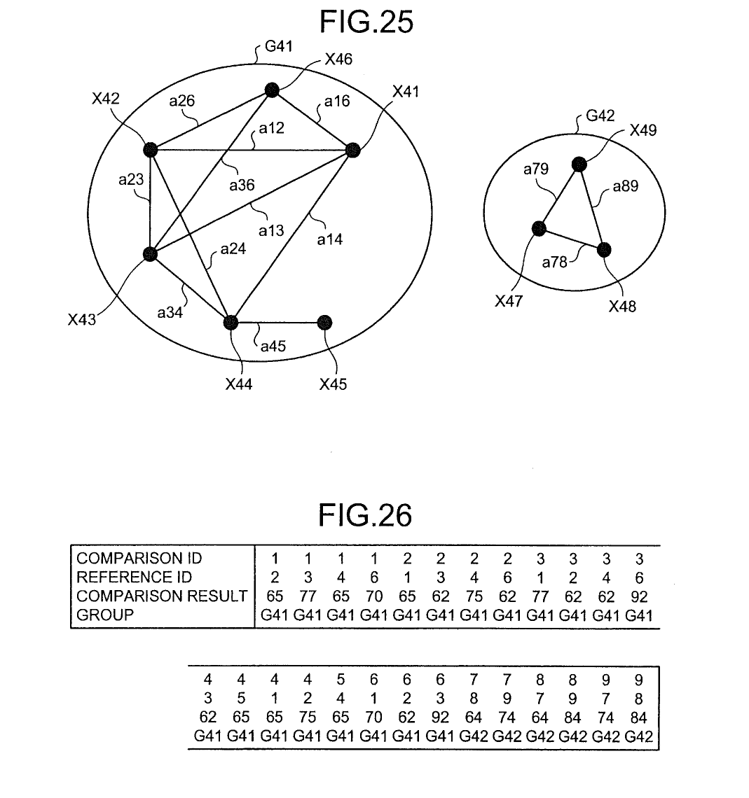

For example, as depicted in FIG. 25, the first to the ninth comparison data X41 to X49 are registered in different groups G41 and G42, respectively, based on the similarity. For example, the first to the sixth comparison data X41 to X46 are registered in group G41, while the seventh to the ninth comparison data X47 to X49 are registered in group G42.

The comparison data and another comparison data are connected by a relationship (hereinafter, “relevance line”) based on the relevance therebetween, if the relevance has been calculated. For example, the first comparison data X41 and the second comparison data X42 are connected by a relevance line a12 in FIG. 25.

The specifying unit 401 sequentially specifies the target data from the data group. For example, the specifying unit 401 sequentially specifies the comparison data from a comparison data group registered in one group. The result of the specification is stored in a storage device such as the RAM 103, the magnetic disk 105, and the optical disk 107.

Each time the specifying unit 401 specifies the target data, the calculating unit 402 calculates, for each of the target data, an evaluation value in the data group based on the relevance between the target data and other data in the data group. For example, each time the specifying unit 401 specifies the comparison data, the calculating unit 402 calculates, for each of the comparison data, an evaluation value in a group based on the relevance with other comparison data in the group.

The calculating unit 402 calculates the evaluation value of the comparison data in the group based on the relevance between comparison data stored in the partner record, for example. The calculating unit 402 may calculate the evaluation value according to multiple methods. The calculated evaluation value is stored in the record for each comparison ID, for example. The result of the calculation is stored in a storage device such as the RAM 103, the magnetic disk 105, and the optical disk 107. FIG. 26 is a diagram of an example of the partner records according to the second embodiment.

As depicted in FIG. 26, the partner record includes the comparison ID and the reference ID. Each partner record (comparison ID, reference ID) may store therein the comparison-data group, for example.

For example, the partner record (1, 2) stores therein the following data: the comparison ID=1; the reference ID=2; and the relevance=65 (comparison result) between the first comparison data X41 and the second comparison data X42. Although a similarity is depicted as the relevance in FIG. 26, the relevance may be any information for comparing the comparison data and the reference data, and may be calculated according to another method.

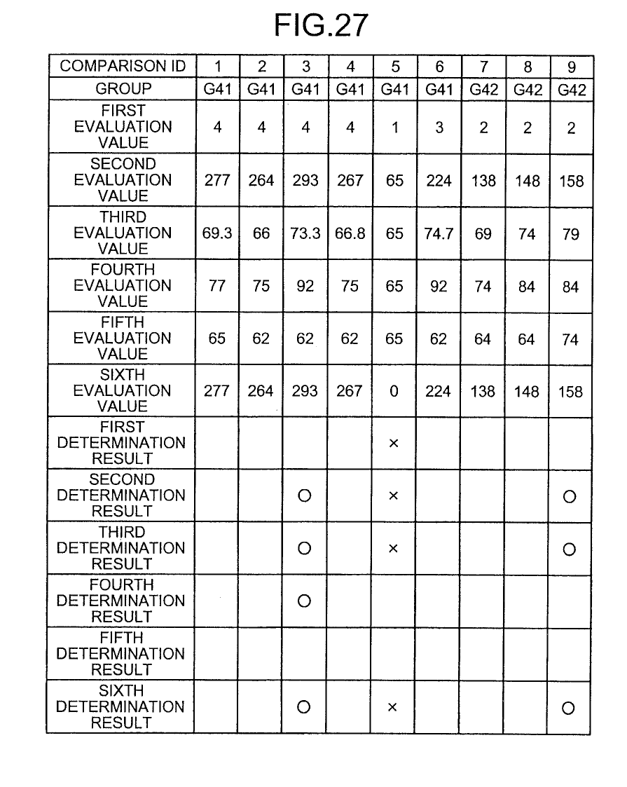

The calculating unit 402 obtains the relevance of the comparison data from the partner records depicted in FIG. 26, for example. FIG. 27 is a diagram of an example of a determination result obtained by the merge process according to the second embodiment.

As depicted in FIG. 27, the determination result record includes the comparison ID, for example. Each determination result record (comparison ID) stores therein the comparison-data group, the evaluation value calculated by the calculating unit 402, and the determination result determined by the determining unit 403, for example.

The calculating unit 402 calculates, for each of the target data, the evaluation value in the data group based on the number of other data that are relevant to the target data. For example, the calculating unit 402 calculates the number of relevance lines that extend from the comparison data to other data as the evaluation value (hereinafter, “first evaluation value”).

In FIG. 25, the first comparison data X41 of group G41 are connected with the second, third, fourth, and sixth comparison data X42, X43, X44, and X46 by relevance lines a12, a13, a14, and a16, respectively. Thus, the calculating unit 402 calculates the first evaluation value of the first comparison data X41 as 4.

The calculating unit 402 also calculates, for each of the target data, the evaluation value in the data group based on the sum of the relevance of other data that are relevant to the target data. For example, the calculating unit 402 calculates the sum of the relevance between comparison data as the evaluation value (hereinafter, “second evaluation value”).

In FIG. 26, the similarity is set between the first comparison data X41 of group G41 and each of the second, third, fourth, and sixth comparison data X42, X43, X44, and X46. Thus, the calculating unit 402 calculates the second evaluation value of the first comparison data X41 as 277 (=65+77+65+70).

The calculating unit 402 also calculates, for each of the target data, the evaluation value in the data group based on the number of other data that are relevant to the target data and the sum of the relevance of the other data. For example, the calculating unit 402 calculates the average of the relevance between comparison data as the evaluation value (hereinafter, “third evaluation value”).

In FIG. 26, the calculating unit 402 calculates the third evaluation value of the first comparison data X41 as 69.3 (=the second evaluation value/the first evaluation value).

The calculating unit 402 also calculates, for each of the target data, the evaluation value in the data group based on the maximum value of the relevance of the other data that are relevant to the target data. For example, the calculating unit 402 selects the maximum value of the relevance between the target data and the other data as the evaluation value (hereinafter, “fourth evaluation value”).

For example, if the relevance is represented by the similarity between data, the higher the fourth evaluation value is, the more the target data are likely to be mergeable with the other data in the group. For example, if the relevance is represented by the dissimilarity between data, the higher the fourth evaluation value is, the more the target data are likely to be unmergeable with the other data in the group.

In FIG. 26, the relevance between the first comparison data X41 and each of the second, third, fourth, and sixth comparison data X42, X43, X44, and X46 is 65, 77, 65, and 70. Thus, the calculating unit 402 calculates the fourth evaluation value of the first comparison data X41 as 77.

The calculating unit 402 also calculates, for each of the target data, the evaluation value in the data group based on the minimum value of the relevance of the other data that are relevant to the target data. For example, the calculating unit 402 selects the minimum value of the relevance between the target data and the other data as the evaluation value (hereinafter, “fifth evaluation value”).

For example, if the relevance is represented by the similarity between data, the lower the fifth evaluation value is, the more the target data are likely to be unmergeable with the other data in the group. For example, if the relevance is represented by the dissimilarity between data, the lower the fifth evaluation value is, the more the target data are likely to be mergeable with the other data in the group.

For example, if the relevance is represented by the similarity between data, the calculating unit 402 calculates the fifth evaluation value as follows. In FIG. 26, the relevance between the first comparison data X41 and each of the second, third, fourth, and sixth comparison data X42, X43, X44, and X46 is 65, 77, 65, and 70. Thus, the calculating unit 402 calculates the fifth evaluation value of the first comparison data X41 as 65.

The calculating unit 402 may also calculate the evaluation value by combining two or more of the first to the fifth evaluation values (hereinafter, “sixth evaluation value”). The calculating unit 402 can change the combination according to various methods of calculating the evaluation value, and for example, combines the first and the third evaluation values if the first and the second evaluation values cannot be combined.

In theory, there are 26 (=₅C₂+₅C₃+₅C₄+₅C₅) calculation methods for the sixth evaluation value. Thus, in theory, the total number of the calculation methods for the evaluation value is 31 (=5 for the first to the fifth evaluation value+26 for the sixth evaluation value). These calculation methods for the evaluation value are examples, and the evaluation value can be calculated according to various methods. The number of the evaluation values is also an example, and may be more or less.

The determining unit 403 determines representative comparison data from the data group based on the evaluation value calculated by the calculating unit 402. For example, the determining unit 403 determines, from the comparison data group in the group, representative comparison data that are mergeable with all other comparison data, based on the evaluation value calculated by the calculating unit 402. The determination result is stored in a storage device such as the RAM 103, the magnetic disk 105, and the optical disk 107.

If the relevance is represented by the similarity between data, the determining unit 403 determines the target data having the maximum evaluation value as the representative comparison data. For example, if the relevance between comparison data is represented by the similarity, the determining unit 403 determines the comparison data having the maximum relevance between comparison data as the representative comparison data.

The determining unit 403 may determine the representative comparison data from the comparison data group in the group by combining the first to the sixth determination results.

For example, in FIG. 27, “O” in the first to the sixth determination results indicates that the evaluation value is the highest, while “X” indicates that the evaluation value is the lowest. For example, if the representative comparison data of group G1 is determined using the second evaluation value, the determining unit 403 determines the third comparison data X43 as the representative comparison data since the second evaluation value=293 of the third comparison data X43 is the highest.

The determining unit 403 determines the target data having the minimum evaluation value as a candidate of data that are unmergeable with the representative comparison data. The candidate is a candidate of data that are likely to be unmergeable with the representative comparison data. The determining unit 403 may determine the target data having an evaluation value lower than a given value as the candidate.

For example, if the relevance between comparison data is represented by the similarity, the determining unit 403 determines the comparison data having the lowest, or a lower relevance between comparison data than a given value, as the candidate of data that are unmergeable with the representative comparison data determined by the determining unit 403. The efficiency of merging is improved by narrowing data to be checked by the operator down to data having a low evaluation value.

If the relevance is represented by the dissimilarity between data, the determining unit 403 determines the target data having the minimum evaluation value as the representative comparison data. For example, if the relevance between comparison data is represented by the dissimilarity, the determining unit 403 determines the comparison data having the minimum relevance between comparison data as the representative comparison data.

If the relevance is represented by the dissimilarity between data, the determining unit 403 determines the target data having the maximum evaluation value as the candidate of data that are unmergeable with the representative comparison data. If the relevance is represented by the dissimilarity between data, the determining unit 403 may determine the target data having an evaluation value higher than a given value as the candidate. The efficiency of merging is improved by narrowing data to be checked by the operator down to data having a high evaluation value.

According to the second embodiment, the number of data included in the merge result can be reduced to a realistic number that can be checked by the operator, enabling the operator can check only a promising or a doubtful merge result even if the merge process is performed based on a vague merge condition, thereby improving the efficiency of the merge process.

Further, since the evaluation value is calculated for each datum of mergeable data, it can be checked for each datum whether the datum may be included in the mergeable data based on the evaluation value. That is, whether each datum in the mergeable data may be or may not be included in the therein can be visualized. Thus, by checking the evaluation value, the operator can check an unexpected merge result that cannot be obtained by the conventional merge process.

Furthermore, the operator can narrow down the merge result to be checked based on the evaluation value. For example, if the relevance is represented by the similarity and candidates of mergeable data are to be checked, the operator need only check data having a high evaluation value. If candidates of unmergeable data are to be checked, the operator need only check data having a low evaluation value.

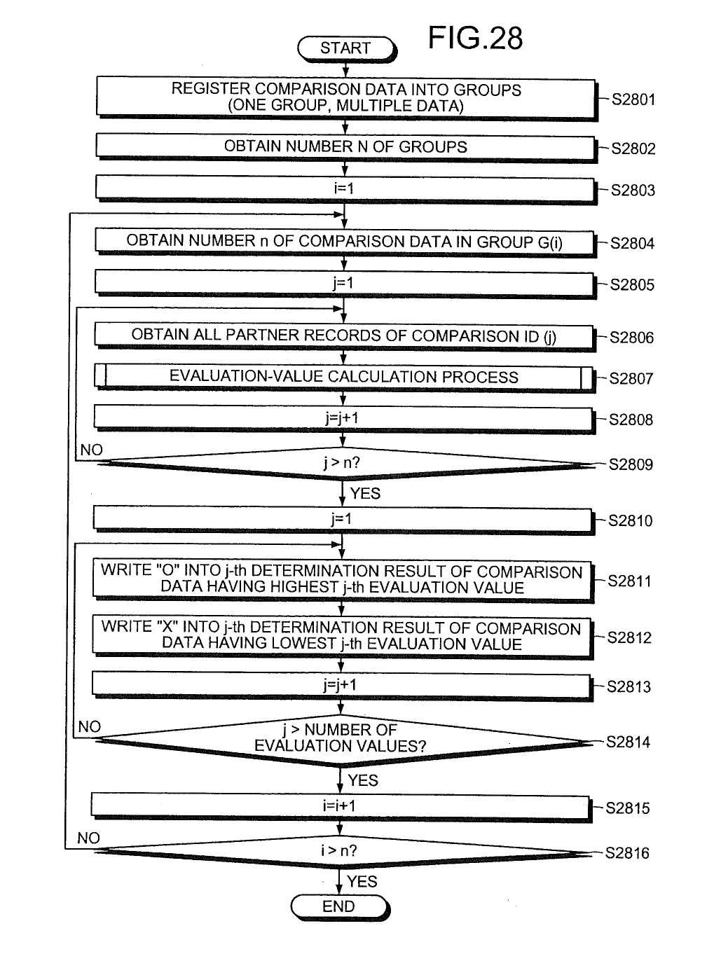

FIG. 28 is a flowchart of an exemplary procedure of the merge process according to the second embodiment. As depicted in FIG. 28, the merging apparatus registers multiple comparison data into groups (step S2801). The specifying unit 401 obtains the number (N) of groups, and sets i to the initial value 1 (i=1) (steps S2802 and S2803).

The specifying unit 401 obtains the number (n) of comparison data in group G(i), and sets j to the initial value 1 (j=1) (steps S2804 and S2805). The calculating unit 402 obtains all partner records having comparison ID (j) (step S2806).

The calculating unit 402 performs the evaluation-value calculation process (step S2807). j is incremented (step S2808) and if j does not exceed n (step S2809: NO), the process transitions to step S2806 and the calculating unit 402 obtains all partner records having comparison ID (j).

If j exceeds n (step S2809: YES), the determining unit 403 sets j, which indicates the number of calculation methods for the evaluation value, to the initial value 1 (j=1) (step S2810). The determining unit 403 writes “O” into the j-th determination result of the comparison data having the highest j-th evaluation value (step S2811).

The determining unit 403 writes “X” into the j-th determination result of the comparison data having the lowest j-th evaluation value (step S2812). j is incremented (step S2813) and if j does not exceed the number of evaluation values (=6 in the example of FIG. 27) (step S2814: NO), the process transitions to step S2811.

Steps S2811 to S2813 are repeated until j exceeds the number of evaluation values (step S2814: YES), and the determining unit 403 writes the determination result of each calculation method of the evaluation value into the determination result of the comparison data (see FIG. 27). Here, the number of calculation methods for the evaluation value is 6, but may be more or less.

If j is exceeds the number of evaluation values (step S2814: YES), i is incremented (step S2815) and if i does not exceed n (step S2816: NO), the process transitions to step S2804 and the number (n) of comparison data in group G(i) is obtained and j is set to the initial value 1 (j=1) (steps S2804 and S2805).

If i exceeds n (i>n) (step S2816: YES), the merging apparatus ends the sequence of processes. After the merge process is ended, the comparison data having the most number of “O”s in the determination result may be determined as the representative comparison data.

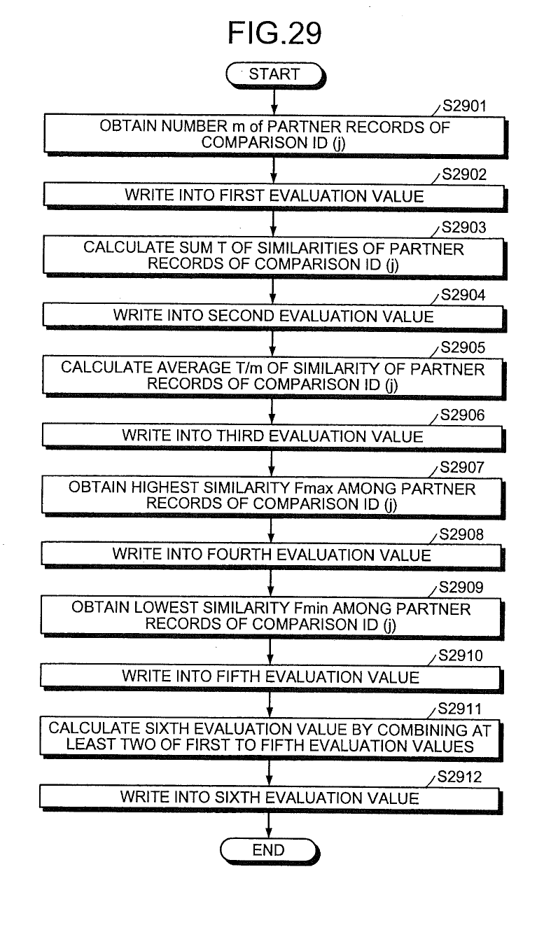

FIG. 29 is a flowchart of an exemplary procedure of the evaluation-value calculation process according to the second embodiment. The calculating unit 402 obtains the number (m) of partner records having comparison ID (j) (step S2901), and writes m into the first evaluation value of the partner records having comparison ID (j) (step S2902).

At step S2902, the calculating unit 402 writes the number of relevance lines of the comparison data of comparison ID (j) into the first evaluation value of the partner records having comparison ID (j) (not depicted in FIG. 26). Here, the evaluation value is written into the partner records. Alternatively, the evaluation value and the determination result may be written into other newly-generated records having a different configuration as described above (see FIG. 27).

The calculating unit 402 calculates the sum T of similarities of the partner records having comparison ID (j) (step S2903), and writes the sum T into the second evaluation value of the partner records having comparison ID (j) (step S2904).

The calculating unit 402 calculates the average T/m of the similarity of the partner records having comparison ID (j) (step S2905), and writes the average T/m into the third evaluation value of the partner records having comparison ID (j) (step S2906).

The calculating unit 402 obtains the highest similarity Fmax among the similarities of the partner records having comparison ID (j) (step S2907), and writes the similarity Fmax into the fourth evaluation value of the partner records having comparison ID (j) (step S2908).

The calculating unit 402 obtains the lowest similarity Fmin among the similarities of the partner records having comparison ID (j) (step S2909), and writes the similarity Fmin into the fifth evaluation value of the partner records having comparison ID (j) (step S2910).

The calculating unit 402 calculates the sixth evaluation value by combining at least two of the first to the fifth evaluation values (step S2911), and writes the calculated value into the sixth evaluation value of the partner records having comparison ID (j) (step S2912), thereby ending the sequence of processes.

In the evaluation-value calculation process depicted in FIG. 29, all of the first to the sixth evaluation values are sequentially calculated. However, this calculation process is an example and may be changed so that the calculating unit 402 calculates, for example, all evaluation values or at least one of the evaluation values. Specifically, the calculating unit 402 may calculate all of the first to the sixth evaluation values, or only the first evaluation value, for example.

The calculating unit 402 may write only one evaluation value into the partner record if the calculating unit 402 calculates the evaluation value by combining multiple evaluation values. Specifically, the calculating unit 402 may write only the sixth evaluation value into the partner record without writing the first to the fifth evaluation values.

The merge process according to the second embodiment can be applied to not only partner records depicted in FIG. 26, but also a case in which groups including multiple data are generated. For example, the merge process according to the second embodiment may be applied to the group integrated by the integrating unit 304 according to the first embodiment.

As described above, the embodiments identify mergeable (or unmergeable) data efficiently, thereby reducing the operation involving the operator and improving the accuracy of the merge result.

Further, the embodiments calculate, for each datum in a data group, an evaluation value in the data group, thereby reducing the number of data included in the merge result to be checked by the operator, and improving the efficiency of the merge process.

The merging method described in the present embodiments can be implemented by executing a preliminarily prepared program, the program being executed by a computer such as a personal computer and a workstation. The merging program is recorded on a computer-readable non-transitory recording medium such as a hard disk, a flexible disk, a CD-ROM, an MO, and a DVD and is read from the recording medium by the computer for execution. The merging program may be distributed through a network such as the Internet.

According to the disclosed technology, the man-hour of merge operation by the operator can be reduced, and a discrepancy can be prevented from occurring in the merge result.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable, non-transitory medium storing a merging program that causes a computer capable of accessing a database that stores therein a data group to execute a process, the process comprising:
specifying, from the data group, first data and second data that are mergeable;
identifying, from the data group, third data that are mergeable with the first data specified at the specifying;
determining the second data specified at the specifying and the third data identified at the identifying as mergeable data; and
outputting a determination result obtained at the determining.

2. The computer-readable, non-transitory medium according to claim 1, wherein
the identifying includes identifying, from the data group, fourth data that are mergeable with the first data specified at the specifying, and
the determining includes determining the second data and the fourth data identified at the identifying as mergeable data, and determining the third data and the fourth data as mergeable data.

3. The computer-readable, non-transitory medium according to claim 1, wherein
the identifying includes identifying, from the data group, fourth data that are unmergeable with the first data specified at the specifying, and
the determining includes determining the second data and the fourth data identified at the identifying as unmergeable data, and determining the third data and the fourth data as unmergeable data.

4. A computer-readable, non-transitory medium storing a merging program that causes a computer capable of accessing a database that stores therein a data group to be merged to execute a process, the process comprising:
specifying, from the data group, first data and second data that are mergeable;
identifying, from the data group, third data that are unmergeable with the first data specified at the specifying;
determining the second data specified at the specifying and the third data identified at the identifying as unmergeable data; and
outputting a determination result obtained at the determining.

5. A computer-readable, non-transitory medium storing a merging program that causes a computer capable of accessing a database that stores therein a data group of data that are relevant to each other to execute a process, the process comprising:
specifying target data from the data group sequentially;
calculating, for each of the target data, an evaluation value in the data group, based on relevance between the target data and other data in the data group each time the target data are specified at the specifying;
determining, from the data group, representative data that are mergeable with all of the other data based on the evaluation value calculated at the calculating; and
outputting a determination result obtained at the determining.

6. The computer-readable, non-transitory medium according to claim 5, wherein the calculating includes calculating, for each of the target data, the evaluation value in the data group, based on the number of the other data that are relevant to the target data.

7. The computer-readable, non-transitory medium according to claim 5, wherein the calculating includes calculating, for each of the target data, the evaluation value in the data group, based on the sum of the relevance of the other data that are relevant to the target data.

8. The computer-readable, non-transitory medium according to claim 5, wherein the calculating includes calculating, for each of the target data, the evaluation value in the data group, based on the number of and the sum of the relevance of the other data that are relevant to the target data.

9. The computer-readable, non-transitory medium according to claim 5, wherein the calculating includes calculating, for each of the target data, the evaluation value in the data group, based on the maximum value of the relevance of the other data that are relevant to the target data, if the relevance is represented by similarity between data.

10. The computer-readable, non-transitory medium according to claim 5, wherein the calculating includes calculating, for each of the target data, the evaluation value in the data group based on the minimum value of the relevance of the other data that are relevant to the target data, if the relevance is represented by dissimilarity between data.

11. The computer-readable, non-transitory medium according to claim 5, wherein the determining includes determining the target data having the highest evaluation value as the representative data if the relevance is represented by similarity between data.

12. The computer-readable, non-transitory medium according to claim 11, wherein the determining includes determining the target data having the lowest evaluation value as a candidate of data that are unmergeable with the representative data.

13. The computer-readable, non-transitory medium according to claim 12, wherein the determining includes determining the target data having an evaluation value lower than a given value as the candidate of data that are unmergeable with the representative data.

14. The computer-readable, non-transitory medium according to claim 5, wherein the determining includes determining the target data having the lowest evaluation value as the representative data if the relevance is represented by dissimilarity between data.

15. The computer-readable, non-transitory medium according to claim 14, wherein the determining includes determining the target data having the highest evaluation value as a candidate of data that are unmergeable with the representative data.

16. The computer-readable, non-transitory medium according to claim 15, wherein the determining includes determining the target data having an evaluation value higher than a given value as the candidate of data that are unmergeable with the representative data.

17. A merging method comprising:
specifying, from a data group, first data and second data that are mergeable;
identifying, from the data group, third data that are mergeable with the first data specified at the specifying;
determining the second data specified at the specifying and the third data identified at the identifying as mergeable data; and
outputting a determination result obtained at the determining.

18. A merging method comprising:
specifying, from a data group to be merged, first data and second data that are mergeable;
identifying, from the data group, third data that are unmergeable with the first data specified at the specifying;
determining the second data specified at the specifying and the third data identified at the identifying as unmergeable data; and
outputting a determination result obtained at the determining.

19. A merging method comprising:
specifying sequentially target data from a data group of data that are relevant to each other;
calculating, for each of the target data, an evaluation value in the data group, based on relevance between the target data and other data in the data group each time the target data are specified at the specifying;
determining, from the data group, representative data that are mergeable with all of the other data based on the evaluation value calculated at the calculating; and
outputting a determination result obtained at the determining.

20. A merging apparatus capable of accessing a database that stores therein a data group, comprising:
a specifying unit that specifies, from the data group, first data and second data that are mergeable;
an identifying unit that identifies, from the data group, third data that are mergeable with the first data specified by the specifying unit;
a determining unit that determines the second data specified by the specifying unit and the third data identified by the identifying unit as mergeable data; and
an output unit that outputs a determination result obtained by the determining unit.

21. A merging apparatus capable of accessing a database that stores therein a data group to be merged, the merging apparatus comprising:
a processor to execute a procedure, the procedure including:
specifying, from the data group, first data and second data that are mergeable;
identifying, from the data group, third data that are unmergeable with the first data specified by the specifying;
determining the second data specified by the specifying and the third data identified by the identifying as unmergeable data; and
outputting a determination result obtained by the determining.

22. A merging apparatus capable of accessing a database that stores therein a data group of data that are relevant to each other, the merging apparatus comprising:
a processor to execute a procedure, the procedure including:
specifying target data from the data group sequentially;
calculating, for each of the target data, an evaluation value in the data group based on a relevance between the target data and other data in the data group each time the target data are specified by the specifying;
determining, from the data group, representative data that are mergeable with all of the other data based on the evaluation value calculated by the calculating; and
outputting a determination result obtained by the determining.
